(19) United States
(12) Patent Application Publication
(10) Pub. No.: US 2006/0285962 A1
(43) Pub. Date: Dec. 21, 2006

(54) Swing boom pivot mechanism

(76) Inventors: Gerald Dyck, British Columbia (CA); Paul Dries, British Columbia (CA); Brent Snipstead, British Columbia (CA)

Correspondence Address: VERMETTE & CO., BOX 40, GRANVILLE SQUARE, SUITE 230 - 200 GRANVILLE STREET, VANCOUVER, BC, V6C 1S4, CA

(21) Appl. No.: 10/553,289

(22) PCT Filed: Apr. 19, 2004
(86) PCT No.: PCT/CA04/00577

§ 371 Date: Oct. 14, 2005

Related U.S. Application Data
(60) Provisional application No. 60/463,349, filed on Apr. 17, 2003.

(51) Int. Cl. B66C 23/00

(52) U.S. Cl. 414/695.8

(57) ABSTRACT

The present invention relates to a swing boom assembly (10), which has a fixed base (52), a pivot base (40) rotatably mounted on the fixed base, and a boom (60) pivotally coupled to the pivot base. The boom is coupled proximate a lower end of the pivot base and has a hydraulic piston cylinder (59) coupled between the boom and an upper end of the pivot base. The hydraulic piston cylinder is operative to raise and lower the boom. The pivot base has an upper shaft (48), a main body (54) having a pair of spaced apart clevis plates affixed to each end of the upper shaft, and a spherical bearing (50) rigidly mounted around the upper shaft between the clevis plates and said bearing having an outer race rigidly mounted to the fixed base. The hydraulic piston cylinder is coupled to the main body of the pivot base rather than directly to an upper shaft.

### FIELD

The present invention relates to an improved attachment arrangement for mounting a pivot base to the boom of a Swing Boom Assembly used on a skidder.

### BACKGROUND OF THE INVENTION

Skidders are used in the forest industry to retrieve and load felled trees. Most consist of a prime mover, and a grapple attached to the end of a boom. Booms are typically mounted to the prime mover through a base allowing movement in a vertical plane. Side to side movement is accomplished through movement of the prime mover. Added maneuverability can be obtained by adding a pivoting base to which the boom is attached allowing the boom to swing about a vertical axis relative to the prime mover. This type of boom is commonly referred to as a Swing Boom Assembly.

The method of mounting the pivot to the base and boom becomes critical to prevent overloading of components. The boom assembly includes the boom, boom cylinder and grapple.

Referring to FIGS. 1-4, a conventional method of attaching the main body 30 of a pivot base 22 to the boom assembly 32 of a swing boom 11 is shown. A horizontal pin 24 and boom cylinder 26 connect the boom 28 to the pivot base 22. The extension of the boom cylinder 26 controls the amount of vertical motion of the boom 28.

The pivot base 22 further comprises an upper spherical bearing 34, lower spherical bearing 36, and a swivel actuator 38. The upper spherical bearing 34, and lower spherical bearing 36 permit the main body 30 of the pivot base 22 to rotate about a vertical axis relative to the fixed base 40. The swivel actuator 38 controls the amount of horizontal rotation of the pivot base 22 and boom 28 about the vertical axis.

As shown in FIG. 1, conventional designs incorporate an upper pivot shaft 42, and lower pivot shaft 64 rigidly attached to the main body 30 of the pivot base 22. The upper pivot shaft 42 passes through the upper spherical bearing 34, and the lower pivot shaft 44 passes through the lower spherical bearing 36. The outer races of the upper and lower spherical bearings 34 and 36 are rigidly attached to the fixed base 40.

As best shown in FIGS. 2-4, the upper pivot shaft 42 extends past the upper spherical bearing 34. A clevis joint 46 is used to connect the boom cylinder 26 to the upper pivot shaft 42. The line of action of the boom cylinder 26 passes through the upper pivot shaft 42 above the upper spherical bearing 34 creating an overhung loading condition. Depending on the particular loading and position of the boom assembly 32 in the vertical plane, stresses due to the bending moment can become excessive, especially at the connection between the upper pivot shaft 42 and the main body 30 (see FIG. 4). As a result, the conventional method of attachment can lead to cracking and failure of the components comprising the vertical axis of the pivot base under severe operating conditions. As such, there is a need for an improved attachment method for mounting the pivot base to the boom assembly.

### SUMMARY

The present invention relates to a swing boom assembly, which has a fixed base, a pivot base rotatably mounted on the fixed base, and a boom pivotally coupled to the pivot base. The boom is coupled proximate a lower end of the pivot base and has a hydraulic piston cylinder coupled between the boom and an upper end of the pivot base. The hydraulic piston cylinder is operative to raise and lower the boom. The pivot base has an upper shaft, a main body having a pair of spaced apart clevis plates affixed to each end of the upper shaft, and a spherical bearing rigidly mounted around the upper shaft between the clevis plates and said bearing having an outer race rigidly mounted to the fixed base.

The hydraulic cylinder assembly may be pivotally coupled to the pivot base at a level intermediate to the clevis plates.

The clevis plates are preferably integral with the main body.

### BRIEF DESCRIPTION OF THE DRAWINGS

Further features and advantages of the invention will be apparent from the following detailed description, given by way of a preferred embodiment taken in conjunction with the accompanying drawings, wherein:

FIG. 1 is a vertical sectional view through the middle of the prior art conventional pivot base connection;

FIG. 2 is a perspective view of the prior art conventional pivot base connection;

FIG. 3 is a side view of the prior art main body of the pivot base and conventional upper joint;

FIG. 4 is a sectional view along line 1-1 of FIG. 2;

FIG. 5A is a perspective view of an improved Swing Boom Assembly in a neutral pivot position;

FIG. 5B is a perspective view of an improved Swing Boom Assembly in a neutral pivot position;

FIG. 6 is a vertical sectional view through the middle of the improved pivot base connection;

FIG. 7 is a perspective view of the improved pivot base connection

FIG. 8 is a side view of the main body of the pivot base and improved upper line; and

FIG. 9 is a sectional view along line 2-2[of FIG. 8

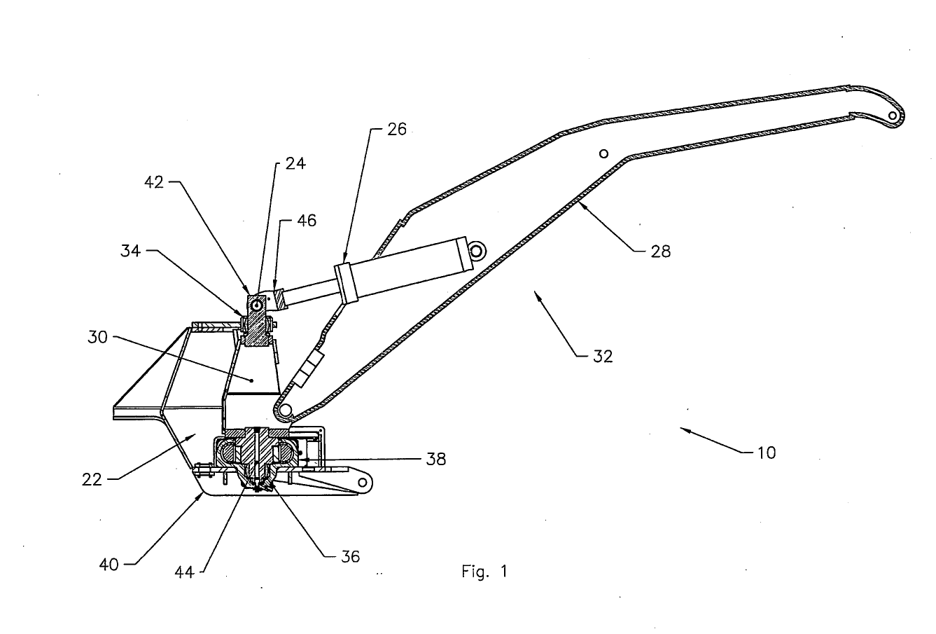

### DETAILED DESCRIPTION

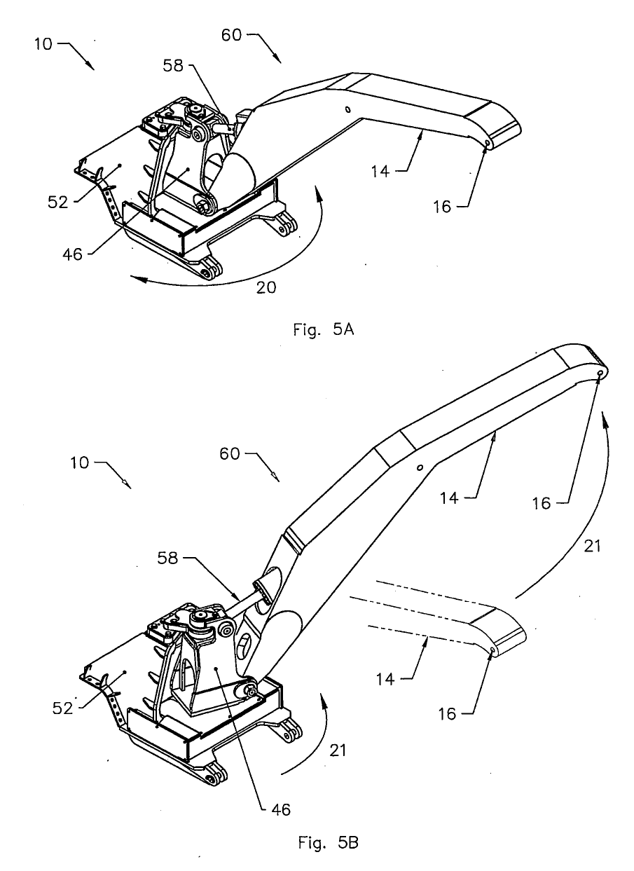

Referring to FIGS. 5A and 5B the movement of the main parts of a swing boom 10 are shown. A fixed base 52 is mounted rigidly to the prime mover (not shown). The boom assembly 60 is attached to the pivot base 46. The boom assembly 60 includes the boom 14, boom cylinder 58, and grapple (not shown). The grapple attaches to the boom 14 at the grapple attachment point 16. The pivot base 46 rotates from side to side as shown by double sided arrow 20 in FIG. 5A. The pivot base 46 is shown rotated counterclockwise in FIG. 5B. The extension of the boom cylinder 58 controls the amount of vertical motion of the boom 14. The boom 14 may move in a horizontal plane with the movement of the pivot base 46 as shown by arrows 20, as well as a vertical plane as illustrated by arrows 21 in FIG. 5B.

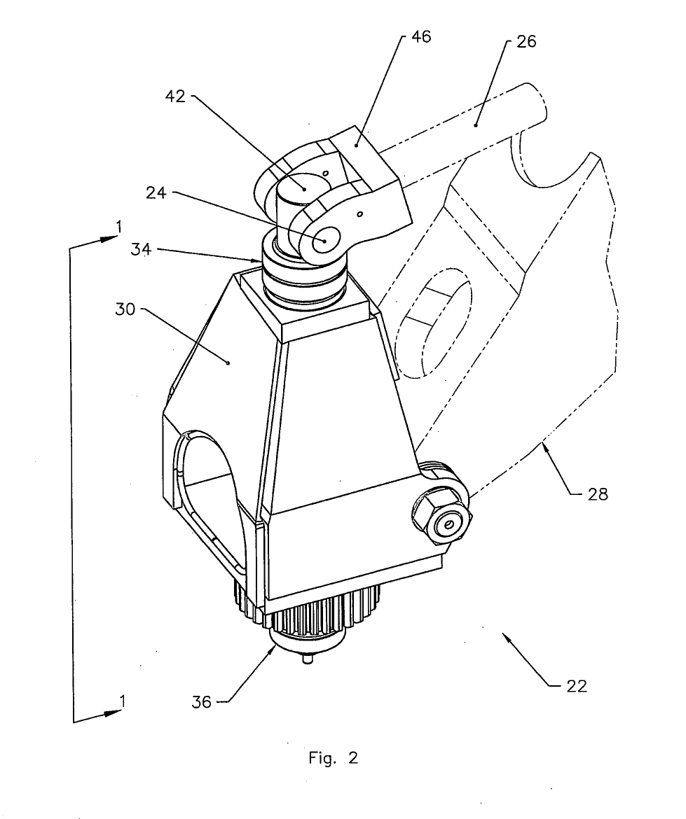

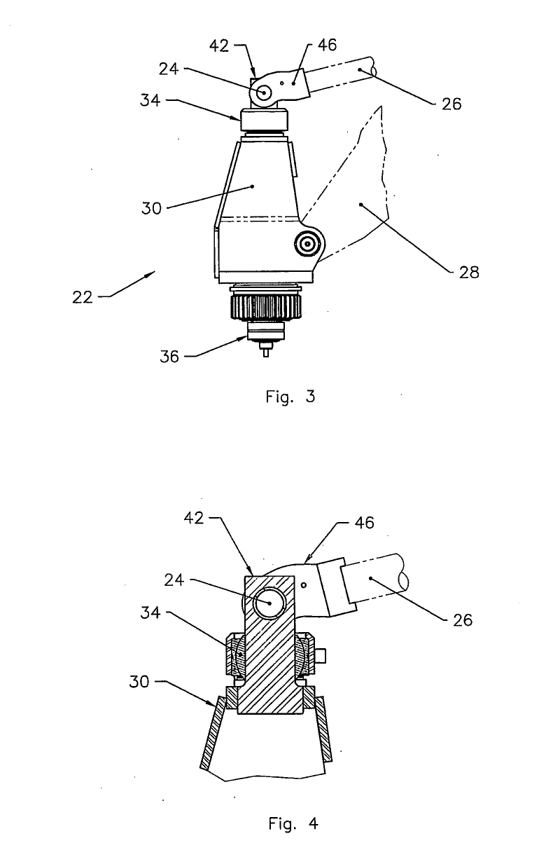

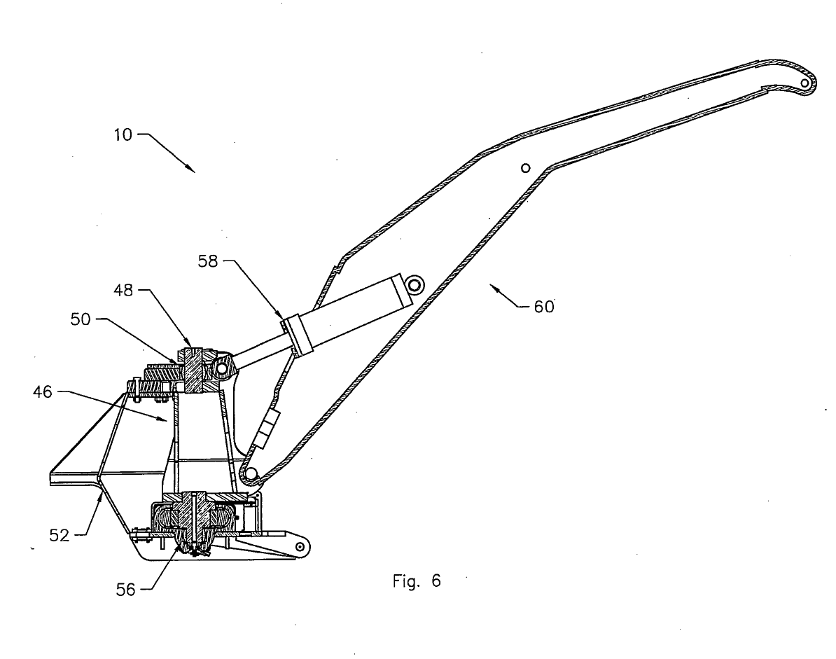

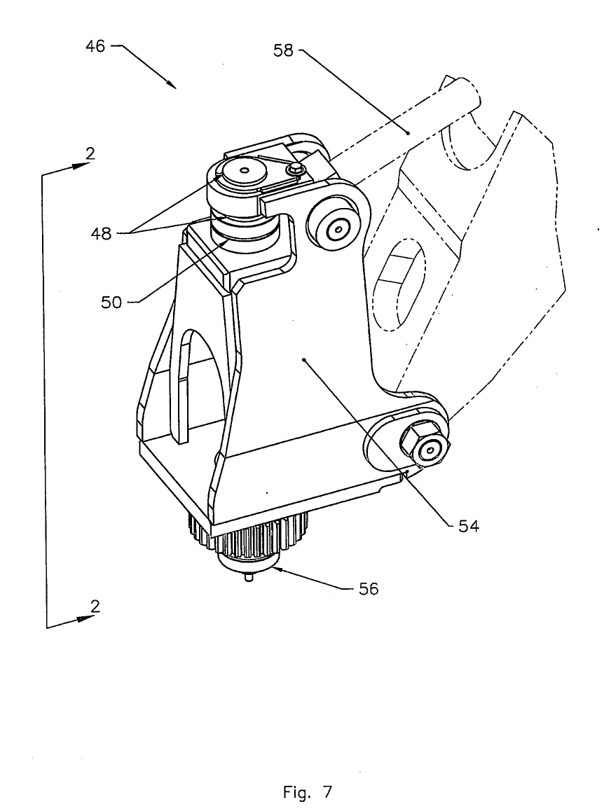

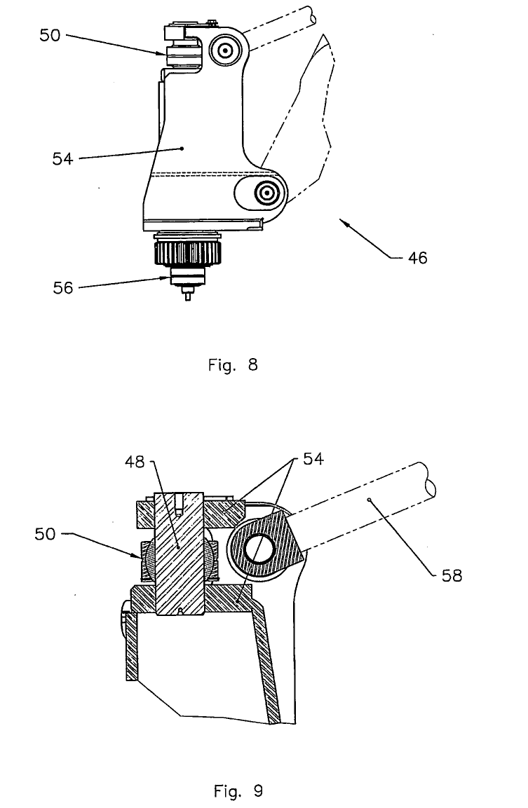

Referring to FIGS. 6-9, an improved design for the attachment of the main body 54 of a pivot base 46 to the boom assembly 60 is mounted to the main body 54 of the pivot base 46. The pivot base 46 is modified from the conventional method described in connection with FIGS. 2-5 at the upper pivot shaft 48. Similar to the conventional method, the outer race of the upper spherical bearing 50 is rigidly mounted to the fixed base 52. However, the main body 54 of the pivot base 46 is extended forming an integral clevis around the upper spherical bearing 50, and both ends of the upper pivot shaft 48 are rigidly mounted to the main body 54 (see FIG. 9). Advantageously, the new geometry substantially reduces the bending moment on the upper pivot shaft 48 relative to the main body 54, and resultant stresses in the upper pivot shaft 48.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to the description. It is therefore contemplated that the appended claims will cover any such modifications or embodiments as fall within the true scope of the invention.

We claim:

1. A swing boom assembly, comprising:
(a) a fixed base (52);
(b) a stubby shaft rotatably mounted on said fixed base (52);
(c) a pivot base (46) mounted on said stubby shaft a distance from said fixed base (52) sufficient only to clear said fixed base during rotation;
(d) a boom (14) pivotally coupled to said pivot base (46) proximate a lower end thereof and having a hydraulic piston cylinder.(58) coupled between said boom (14) and an upper end of said pivot base (46) and operative to raise and lower said boom (14);
wherein said pivot base (46) has
(i) an upper shaft (48);
(ii) a main body (52) having a pair of spaced apart clevis plates affixed to each end of said upper shaft (48);
(iii) a bearing (50) rigidly mounted around said upper shaft (48) between said clevis plates and said bearing having an outer race rigidly mounted to said fixed base (52).

2. An assembly according to claim 1,.wherein said hydraulic piston cylinder (58) is pivotally coupled to said pivot base (46) at a level proximate said clevis plates.

3. An assembly according to claim 1, including a swivel actuator (48) mounted on said fixed base (52) and coupled to said stubby shaft, operative to rotate said pivot base (46).

4. An assembly according to claim 1, wherein said upper pivot shaft (48) is removable.

5. An assembly according to claim 1, wherein said fixed base (52) is part of a skidder.

6. An assembly according to claim 1, wherein said pivot base (46) is rigidly affixed to a distal portion of said stubby shaft.

7. An assembly according to claim 1, wherein said clevis plates are integral with said main body (52).

8. An assembly according to claim 1, including a lower bearing (50) coupled to a lower portion of said stubby shaft and having an outer race rigidly coupled to said fixed base (52).

9. The assembly of claim 1, including a bearing (50) coupled to a lower portion of said stubby shaft with an outer race rigidly coupled to said fixed base (52) and said pivot base (46) is rigidly affixed to said stubby shaft and including a swivel actuator (34) mounted on said fixed base (52) and coupled to said stubby shaft, operative to rotate said stubby shaft.
